(19) United States
(12) Patent Application Publication
(10) Pub. No.: US 2013/0332599 A1
(43) Pub. Date: Dec. 12, 2013

(54) NEIGHBOR DISCOVERY OFFLOAD IN MOBILE DEVICES

(71) Applicant: APPLE INC., Cupertino, CA (US)

(72) Inventors: Veerendra Boodannavar, Sunnyvale, CA (US); Kapil Chhabra, Milpitas, CA (US)

(21) Appl. No.: 13/627,970

(22) Filed: Sep. 26, 2012

Related U.S. Application Data
(60) Provisional application No. 61/657,823, filed on Jun. 10, 2012.

(51) Int. Cl. H04W 8/00

(52) U.S. Cl. CPC H04W 8/005
USPC 709/224

(57) ABSTRACT

One embodiment of the present invention provides a system that facilitates offloading neighbor discovery from a host prior to the host entering Wake on Wireless LAN (WoWLAN) mode. During operation, the system receives a request from a host executing on the processor to enter WoWLAN mode. Next, the system collects a set of active IP addresses on the host. The system then places the apparatus in WoWLAN mode. Next, the system receives neighbor discovery requests from IP addresses external to the host at a networking chip external to the processor. The system then responds to the neighbor discovery requests from the networking chip on behalf of the host and without waking the host from WoWLAN mode for requests destined to IP addresses that are members of the set of active IP addresses. Finally, the system also prevents, at the networking chip, the neighbor discovery requests from waking the host.

### RELATED APPLICATIONS

This application hereby claims priority under 35 U.S.C. §119 to U.S. Provisional Patent Application No. 61/657,823, filed on 10 Jun. 2012, entitled “NEIGHBOR DISCOVERY OFFLOAD,” by inventors Veerendra Boodannavar and Kapil Chhabra, having attorney docket number APL-P15576USP1.

### BACKGROUND

1. Field of the Invention

The present invention relates to network devices. More specifically, the present invention relates to a method and an apparatus for facilitating network discovery offload in mobile devices.

2. Related Art

Mobile devices, such as smartphones, tablets, and PDAs, typically have limited power resources, and are typically configured to optimize power savings. One of the ways in which these devices achieve significant power savings is in shutting down services that are not currently being utilized. For example, in many devices, wireless networking accounts for a significant portion of the power consumption. Thus, at times when the network is not being utilized, it is beneficial to shut down the wireless network, or to enter a low-power mode. However, shutting down services can result in other significant drawbacks. For example, if the wireless network is shut down, then the device will not be aware of incoming requests via the wireless network.

In order to alleviate the problem of excessive power consumption by idle wireless networks, many devices employ a feature called Wake on Wireless LAN (WoWLAN). WoWLAN allows a device to shut down most of its wireless services, while listening for specific packets that will wake the device from WoWLAN mode. In this manner, the device can enter a power-saving state until it receives a packet that returns it to a normal operating mode. While this technique results in increased power savings over devices without WoWLAN capabilities, WoWLAN-enabled devices are regularly brought out of WoWLAN mode for routine mundane tasks, or they simply do not respond to or miss some network requests.

### SUMMARY

One embodiment of the present invention provides a system that facilitates offloading neighbor discovery from a host prior to the host entering Wake on Wireless LAN (WoWLAN) mode. During operation, the system receives a request from a host executing on the processor to enter WoWLAN mode. Next, the system collects a set of active IP addresses on the host. The system then places the apparatus in WoWLAN mode. Next, the system receives neighbor discovery requests from IP addresses external to the host at a networking chip external to the processor. The system then responds to the neighbor discovery requests from the networking chip on behalf of the host and without waking the host from WoWLAN mode for requests destined to IP addresses that are members of the set of active IP addresses. Finally, the system also prevents, at the networking chip, the neighbor discovery requests from waking the host.

In some embodiments of the present invention, the system stores the set of active IP addresses in a neighbor discovery table.

In some embodiments of the present invention, the Wireless LAN (WLAN) chip handles the response to the external neighbor discovery requests.

In some embodiments of the present invention, the set of active IP addresses can include IPv4 addresses and IPv6 addresses.

In some embodiments of the present invention, the system stores a set of observed origin IP addresses obtained from neighbor discovery requests.

In some embodiments of the present invention, the system stores the set of observed origin IP addresses in a neighbor discovery table.

In some embodiments of the present invention, the system responds to neighbor discovery requests from the host for IP addresses in the set of observed IP addresses without forwarding the neighbor discovery requests external to the host.

### BRIEF DESCRIPTION OF THE FIGURES

FIG. 1 illustrates a computing environment in accordance with an embodiment of the present invention.

FIG. 2 illustrates an apparatus in accordance with an embodiment of the present invention.

FIG. 3 presents a flow chart illustrating the process of neighbor discovery offload in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a non-transitory computer-readable storage medium, which may be any device or medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed. Note that the term “non-transitory computer-readable storage medium” comprises all computer-readable media, with the sole exception of a propagating electromagnetic signal.

The methods and processes described in the detailed description section can be embodied as code and/or data, which can be stored on a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

One embodiment of the present invention provides a system that facilitates offloading neighbor discovery from a host prior to the host entering Wake on Wireless LAN (WoWLAN) mode. During operation, the system receives a request from a host executing on the processor to enter WoWLAN mode. Next, the system collects a set of active IP addresses on the host. The system then places the apparatus in WoWLAN mode. Next, the system receives neighbor discovery requests from IP addresses external to the host at a networking chip external to the processor. The system then responds to the neighbor discovery requests from the networking chip on behalf of the host and without waking the host from WoWLAN mode for requests destined to IP addresses that are members of the set of active IP addresses. Finally, the system also prevents, at the networking chip, the neighbor discovery requests from waking the host.

In some embodiments of the present invention, the system stores the set of active IP addresses in a neighbor discovery table. Note that in some embodiments, this neighbor discovery table is compliant with the Neighbor Discovery Protocol (NDP).

In some embodiments of the present invention, the Wireless LAN (WLAN) chip handles the response to the external neighbor discovery requests. Thus, by offloading the neighbor discovery requests to the WLAN chip, the system can process neighbor discovery requests as soon as they arrive at the apparatus without waking the host. Not that the host and the WLAN chip are part of the same apparatus, such as a tablet or a smartphone. The host may comprise the operating system processes, while the WLAN chip is a separate chip from the CPU that handles wireless network traffic.

In some embodiments of the present invention, the set of active IP addresses can include IPv4 addresses and IPv6 addresses. Note that, while the description herein discusses IP addresses and Internet Protocol, any form of networking with neighbor discovery may be used.

In some embodiments of the present invention, the system stores a set of observed origin IP addresses obtained from neighbor discovery requests. In some embodiments, the system stores the set of observed origin IP addresses in a neighbor discovery table. In some embodiments, the system responds to neighbor discovery requests from the host for IP addresses in the set of observed IP addresses without forwarding the neighbor discovery requests external to the host. Note that this allows the system to respond to neighbor discovery requests from the host without having to send the neighbor discovery requests out to the network.

### Computing Environment

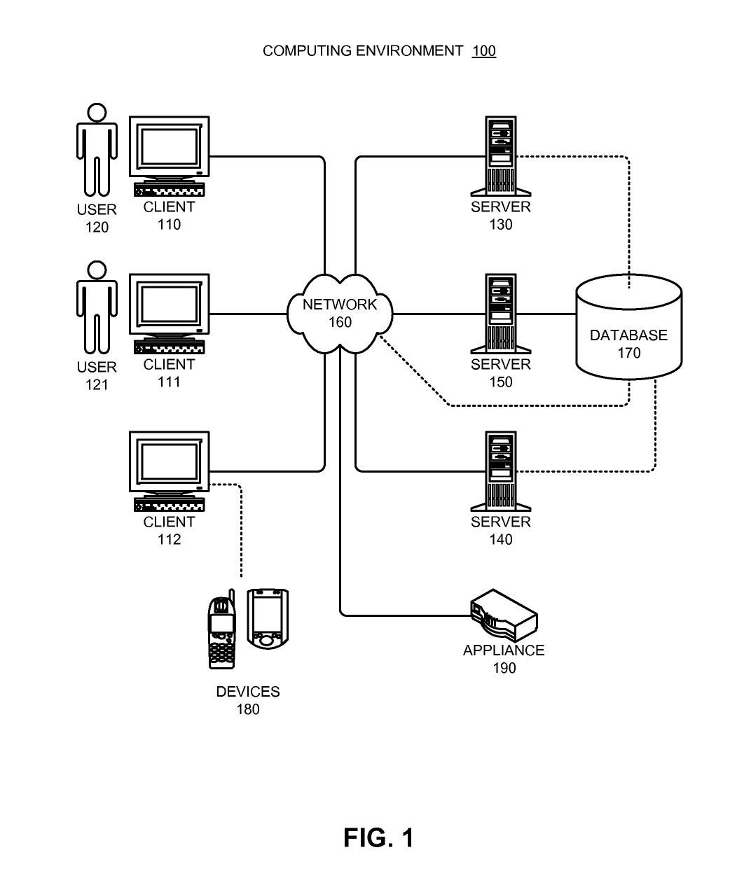

FIG. 1 illustrates a computing environment 100 in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 1, computing environment 100 includes clients 110-112, users 120 and 121, servers 130-150, network 160, database 170, devices 180, and appliance 190.

Clients 110-112 can include any node on a network including computational capability and including a mechanism for communicating across the network. Additionally, clients 110-112 may comprise a tier in an n-tier application architecture, wherein clients 110-112 perform as servers (servicing requests from lower tiers or users), and wherein clients 110-112 perform as clients (forwarding the requests to a higher tier).

Similarly, servers 130-150 can generally include any node on a network including a mechanism for servicing requests from a client for computational and/or data storage resources. Servers 130-150 can participate in an advanced computing cluster, or can act as stand-alone servers. In one embodiment of the present invention, server 140 is an online “hot spare” of server 150.

Users 120 and 121 can include: an individual; a group of individuals; an organization; a group of organizations; a computing system; a group of computing systems; or any other entity that can interact with computing environment 100.

Network 160 can include any type of wired or wireless communication channel capable of coupling together computing nodes. This includes, but is not limited to, a local area network, a wide area network, or a combination of networks. In one embodiment of the present invention, network 160 includes the Internet. In some embodiments of the present invention, network 160 includes phone and cellular phone networks.

Database 170 can include any type of system for storing data in non-volatile storage. This includes, but is not limited to, systems based upon magnetic, optical, or magneto-optical storage devices, as well as storage devices based on flash memory and/or battery-backed up memory. Note that database 170 can be coupled: to a server (such as server 150), to a client, or directly to a network.

Devices 180 can include any type of electronic device that can be coupled to a client, such as client 112. This includes, but is not limited to, cell phones, personal digital assistants (PDAs), smartphones, personal music players (such as MP3 players), gaming systems, digital cameras, video cameras, portable storage media, or any other device that can be coupled to the client. Note that, in some embodiments of the present invention, devices 180 can be coupled directly to network 160 and can function in the same manner as clients 110-112.

Appliance 190 can include any type of appliance that can be coupled to network 160. This includes, but is not limited to, routers, switches, load balancers, network accelerators, and specialty processors. Appliance 190 may act as a gateway, a proxy, or a translator between server 140 and network 160.

Note that different embodiments of the present invention may use different system configurations, and are not limited to the system configuration illustrated in computing environment 100. In general, any device that is capable of communicating via network 160 may incorporate elements of the present invention.

### Apparatus

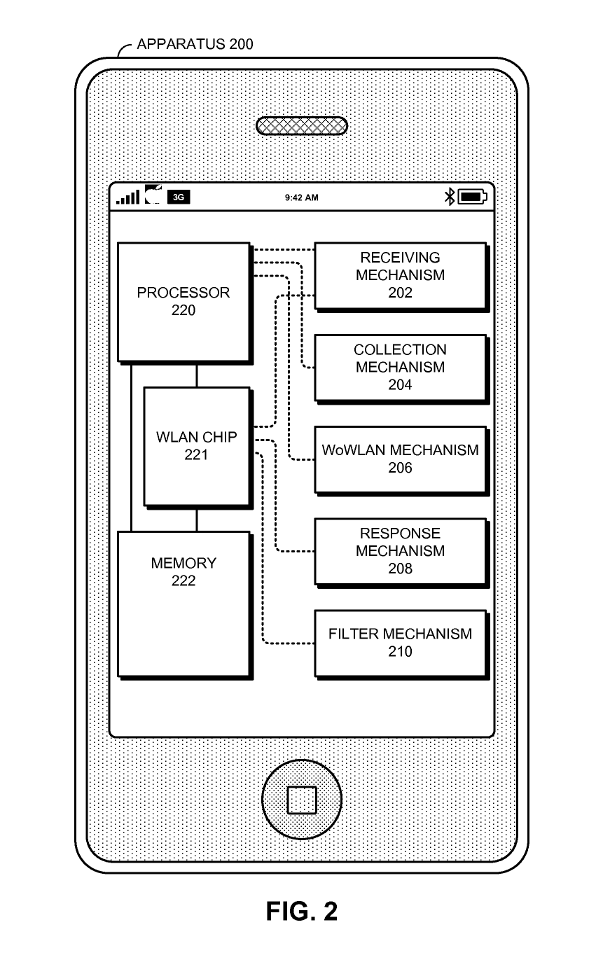

FIG. 2 illustrates an apparatus 200 in accordance with an embodiment of the present invention. As illustrated in FIG. 2, apparatus 200 can include receiving mechanism 202, collection mechanism 204, WoWLAN mechanism 206, response mechanism 208, filter mechanism 210, processor 220, WLAN chip 221, and memory 222.

Additionally, apparatus 200 can include any type of electronic device that can be coupled to a client, such as client 112. This includes, but is not limited to, cell phones, personal digital assistants (PDAs), tablets, smartphones, personal music players (such as MP3 players), gaming systems, digital cameras, video cameras, portable storage media, or any other device that can be coupled to the client.

### Neighbor Discovery Offload

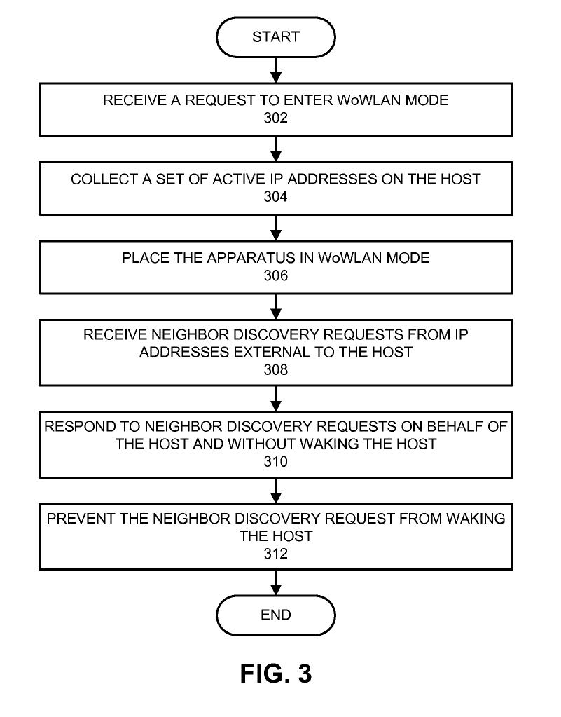

FIG. 3 presents a flow chart illustrating the process of neighbor discovery offload in accordance with an embodiment of the present invention. During operation, receiving mechanism 202 receives a request, from a host executing on apparatus 200, to enter WoWLAN mode (operation 302). Next, collection mechanism 204 collects a set of active IP addresses on the host (operation 304). WoWLAN mechanism 206 then places apparatus 200 in WoWLAN mode (operation 306).

While in WoWLAN mode, receiving mechanism 202 receives neighbor discovery requests from IP addresses external to the host at WLAN chip 221 (operation 308). Response mechanism 208 responds to the neighbor discovery requests from WLAN chip 221 on behalf of the host, and without waking the host from WoWLAN mode, for requests destined to IP addresses that are members of the set of active IP addresses (operation 310). Finally, filter mechanism 210 prevents the neighbor discovery requests from waking the host (operation 312).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An apparatus configured to offload neighbor discovery prior to entering Wake on Wireless LAN (WoWLAN) mode, comprising:
a memory;
a processor;
a networking chip;
a receiving mechanism configured to receive a request, from a host executing on the processor, to enter WoWLAN mode;
a collection mechanism configured to collect a set of active IP addresses on the host;
a WoWLAN mechanism configured to place the apparatus in WoWLAN mode;
wherein the receiving mechanism is further configured to receive neighbor discovery requests from IP addresses external to the host at the networking chip;
a response mechanism on the networking chip configured to respond to the neighbor discovery requests on behalf of the host and without waking the host from WoWLAN mode for requests destined to IP addresses that are members of the set of active IP addresses; and
a filter mechanism on the networking chip configured to prevent the neighbor discovery requests from waking the host.

2. The apparatus of claim 1, wherein the collection mechanism stores the set of active IP addresses in a neighbor discovery table.

3. The apparatus of claim 1, wherein the response mechanism is internal to a Wireless LAN (WLAN) chip.

4. The apparatus of claim 1, wherein the set of active IP addresses can include IPv4 addresses and IPv6 addresses.

5. The apparatus of claim 1, wherein the collection mechanism is further configured to store a set of observed origin IP addresses obtained from neighbor discovery requests.

6. The apparatus of claim 5, wherein the collection mechanism stores the set of observed origin IP addresses in a neighbor discovery table.

7. The apparatus of claim 6, wherein the response mechanism is further configured to respond to neighbor discovery requests from the host for IP addresses in the set of observed IP addresses without forwarding the neighbor discovery requests external to the host.

8. A computer-implemented method for offloading neighbor discovery prior to entering Wake on Wireless LAN (WoWLAN) mode, the method comprising:
receiving a request, by computer, from a host executing on a processor in an apparatus, to enter WoWLAN mode;
collecting, by computer, a set of active IP addresses on the host;
placing, by computer, the apparatus in WoWLAN mode;
receiving, by computer at a networking chip external to the processor, neighbor discovery requests from IP addresses external to the host;
responding, by computer from the networking chip, to the neighbor discovery requests on behalf of the host and without waking the host from WoWLAN mode for requests destined to IP addresses that are members of the set of active IP addresses; and
preventing, by computer from the networking chip, the neighbor discovery requests from waking the host.

9. The computer-implemented method of claim 8, further comprising storing the set of active IP addresses in a neighbor discovery table.

10. The computer-implemented method of claim 8, wherein the set of active IP addresses can include IPv4 addresses and IPv6 addresses.

11. The computer-implemented method of claim 8, further comprising storing a set of observed origin IP addresses obtained from neighbor discovery requests.

12. The computer-implemented method of claim 11, further comprising storing the set of observed origin IP addresses in a neighbor discovery table.

13. The computer-implemented method of claim 12, further comprising responding to neighbor discovery requests from the host for IP addresses in the set of observed IP addresses without forwarding the neighbor discovery requests external to the host.

14. A non-transitory computer-readable storage medium storing instructions that when executed by a computer cause the computer to perform a method for offloading neighbor discovery prior to entering Wake on Wireless LAN (WoWLAN) mode, the method comprising:
receiving a request, by computer, from a host executing on a processor in an apparatus, to enter WoWLAN mode;
collecting, by computer, a set of active IP addresses on the host;
placing, by computer, the apparatus in WoWLAN mode;
receiving, by computer at a networking chip external to the processor, neighbor discovery requests from IP addresses external to the host;
responding, by computer from the networking chip, to the neighbor discovery requests on behalf of the host and without waking the host from WoWLAN mode for requests destined to IP addresses that are members of the set of active IP addresses; and
preventing, by computer from the networking chip, the neighbor discovery requests from waking the host.

15. The non-transitory computer-readable storage medium of claim 14, wherein the method further comprises storing the set of active IP addresses in a neighbor discovery table.

16. The non-transitory computer-readable storage medium of claim 14, wherein the set of active IP addresses can include IPv4 addresses and IPv6 addresses.

17. The non-transitory computer-readable storage medium of claim 14, wherein the method further comprises storing a set of observed origin IP addresses obtained from neighbor discovery requests.

18. The non-transitory computer-readable storage medium of claim 17, wherein the method further comprises storing the set of observed origin IP addresses in a neighbor discovery table.

19. The non-transitory computer-readable storage medium of claim 18, wherein the method further comprises responding to neighbor discovery requests from the host for IP addresses in the set of observed IP addresses without forwarding the neighbor discovery requests external to the host.
